(19) United States
(12) Patent Application Publication
(10) Pub. No.: US 2005/0241783 A1
(43) Pub. Date: Nov. 3, 2005

(54) Screen system

(76) Inventor: David Geres, Winnipeg (CA)

Correspondence Address: ADE & COMPANY, 1700-360 MAIN STREET, WINNIPEG, MB, R3C3Z3, CA

(21) Appl. No.: 11/055,719

(22) Filed: Feb. 11, 2005

(30) Foreign Application Priority Data
Feb. 12, 2004 (CA) 2,457,582

(51) Int. Cl. E06B 3/00

(52) U.S. Cl. 160/368.1

(57) ABSTRACT

A screen system is used to span the opening in a building, for example a door opening in a garage to inhibit entry of insect through the opening. The screen system includes a plurality of fasteners securable about a periphery of the opening. A sheet of screen material includes elastic connectors about a periphery thereof for being adjustably secured to the fasteners with the screen material spanning the opening. Markers, for example indicia or reflectors, may be provided centrally located on the screen material as a visual indicator that the screen is mounted in place.

### FIELD OF THE INVENTION

The present invention relates to a screen system and method of use for spanning screen material across an opening in a building, for example a door opening in a garage.

### BACKGROUND

The use of screens is commonly known for preventing access by mosquitoes or other insects into enclosed spaces. Restricting access by insects prevents annoyance of such insects as well as eliminating the risk of diseases which may be spread by biting insects. Various examples of screen devices are known for spanning openings of windows and doorways in buildings including garages and the like.

Some examples for screens which span garage door openings include U.S. Pat. Nos. 3,455,366 to Bogumile, 3,763,917 to Antinone, 5,271,449 to Herrick, 5,323,835 to Bachmerier and 5,427,169 to Saulters. Among the listed examples, none are suitably arranged for adjustable attachment and ready removal for ease of storage when not in use. Furthermore none are particularly suited for visually indicating to an operator of a vehicle to be parked in the garage that the screen is mounted in place. Lack of visual indication that the screen is in place may be responsible for considerable damage to vehicles or buildings when persons attempt to drive a vehicle through a garage door opening having a screen mounted thereon.

### SUMMARY

According to one aspect of the present invention there is provided a screen system for an opening in a building, the opening having a perimeter frame, the system comprising:

a plurality of fasteners securable to the perimeter frame of the opening at spaced positions therealong; and

a sheet of screen material securable to the fasteners for spanning the opening.

According to a second aspect of the present invention there is provided a method of supporting a sheet of screen material spanning an opening in a building having a perimeter frame, the method comprising:

mounting a plurality of fasteners on the perimeter frame of the opening at spaced positions therealong;

securing a peripheral edge of the sheet of screen material to the fasteners to span the opening.

The use of fasteners secured to the perimeter frame permit the fasteners to remain in place such that the screen material can readily be attached or removed from the fasteners as desired. The configuration of the fasteners is particularly suited for the use of elastic connectors on the peripheral edge of the screen material to adjustably support the screen material across the opening in a taught configuration.

The screen material preferably includes a plurality of connectors at spaced positions about a periphery thereof which are selectively securably to the fasteners, wherein the connectors are formed of resilient elastic material.

When the fasteners include an anchoring portion for securement within the perimeter frame of the opening and a head portion of enlarged diameter, the connectors preferably comprise a loop of elastic material stretchable and securable about the head portion of the fasteners.

When there is provided a horizontally extending seam which spans the screen material, preferably at least one connector is provided in alignment with the seam.

Visual markers may be centrally located within the screen material or along the seam in the screen material, in the form of reflectors or contrasting indicia and the like.

The sheet of flexible screen material is preferably only slightly larger in dimension than a conventional garage door opening size for overlapping the perimeter frame of the door opening along the top and sides thereof. Reinforcement material may be provided along a bottom edge of the screen material, formed in a loop for slidably receiving an elongate rod of rigid material therethrough.

The components of the screen system are all flexible to permit folding thereof for storage after use.

### BRIEF DESCRIPTION OF THE DRAWINGS

In the accompanying drawings, which illustrate an exemplary embodiment of the present invention:

FIG. 1 is a perspective view of the screen system spanning the garage door opening of a typical garage.

FIG. 2 is a front elevational view of the screen material according to the screen system of FIG. 1.

FIG. 3 is a sectional view along the line 3-3 of FIG. 2.

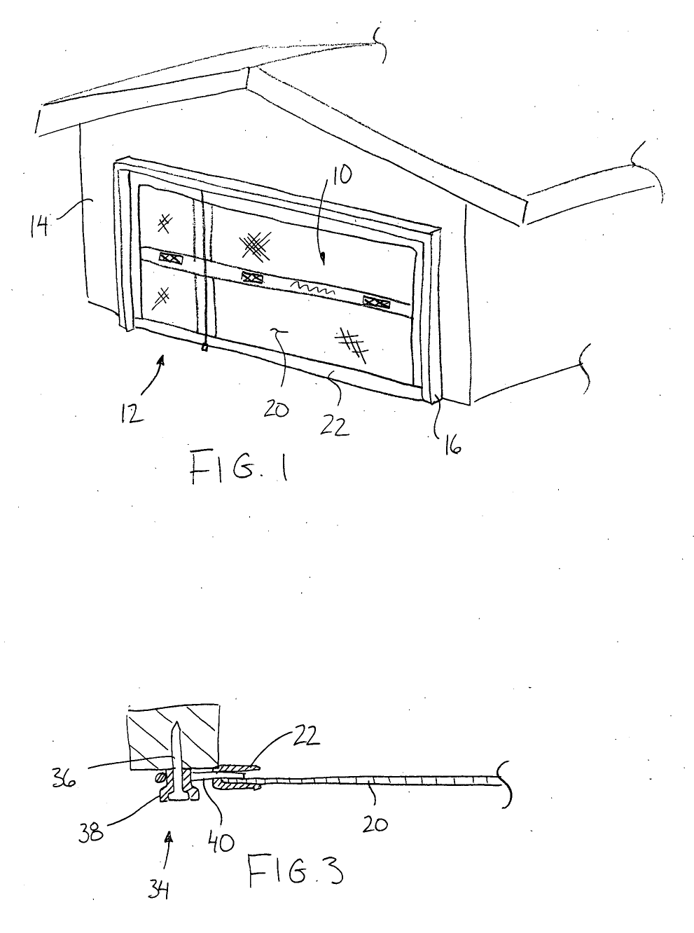

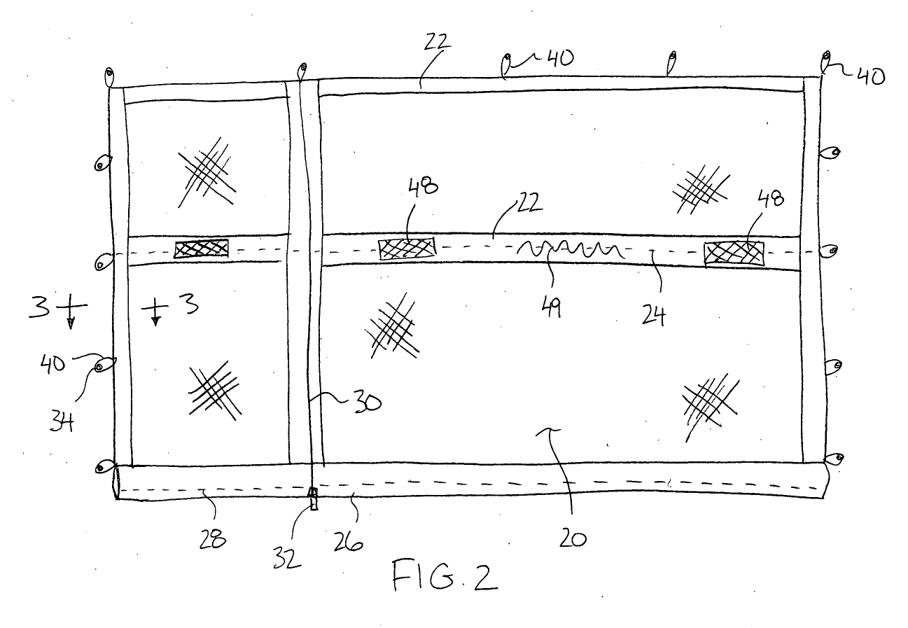

### DETAILED DESCRIPTION

Referring to the accompanying drawings, there is illustrated a screen system generally indicated by reference numeral 10. The screen system is particularly useful for spanning a door opening 12 in a building, for example a garage 14. The door opening 12 in the garage 14 includes a perimeter frame 16 having a pair of parallel and spaced apart vertical side members on opposing sides of the opening from one another and a top member spanning between the side members across a top of the opening. The perimeter frame 16 is open along a bottom side of the door opening at a floor of the garage along the ground.

The screen system 10 includes a sheet of screen material 20 which may be formed in one or more sections. The screen material is typically available in standard rolls of a five foot width in which plural rolls may be attached together with longitudinal horizontal seams so that any one of numerous standard heights of garage door openings in the order of seven to fifteen feet or more can be accommodated. The screen material is trimmed so that the overall size of adjacent strips which are joined together to form a single sheet approximately matches a standard door size with an overlap about a periphery of the door opening at the perimeter frame 16 in the order of one or two inches.

In the illustrated embodiment two strips of screen material are joined at a longitudinally extending seam which is centrally located horizontally across the door opening in a mounted configuration. Fibreglass reinforced vinyl edging material 22 is wrapped about all open edges of the screen material and stitched thereon to cover the edges as well as the longitudinally extending central seam 24. A bottom edge 26 includes edging material 22 which is formed in a loop to define a longitudinally extending hollow chamber which may slidably receive a rigid rod 28 therethrough to provide weight for sealing against the floor of the garage and for adding some rigidity to the structure.

A doorway may be provided in the screen material 20 by providing a vertical seam 30 spanning between the top and bottom edges with the seam being selectively joined together by a suitable zipper 32. Vinyl edging material is again provided along both edges of the vertical seam 30 for added strength along the seam. The edging material, the zipper and the screen material are all flexible to permit the screen to be readily folded for storage when not is use.

In order to mount the screen in place spanning the opening, fasteners 34 are secured to the perimeter frame 16 at spaced positions therealong. Each fastener 34 includes an anchor portion 36 in the form of a conventional screw which is secured by threading into an inner surface of the perimeter frame members 16. The fasteners 34 are secured to the perimeter frame 16 at spaced positions in alignment with the central seam 24, the vertical seam 30, corners of the screen material and numerous other positions in between for alignment with connectors 40 secured about the periphery of the screen material. The fasteners 34 further include a head portion 38 comprising a cylindrical body having a bore therethrough to receiving the anchoring portion therethrough. The head portion 38 includes an enlarged diameter at a free end thereof spaced outwardly from the surface of the perimeter frame member to which it is secured for retaining a respective connector 40 thereon.

Each connector 40 comprises a resilient loop of elastic material which is stitched to the perimeter edging material 22 of the screen for permanent attachment thereto. The connectors 40 are located in alignment with the vertical seam 30, the centre seam 24 and the corners of the screen material, as well as numerous positions spaced therebetween for securement to the respective fasteners 34 which have been mounted on the perimeter frame for alignment therewith. The connectors 40 can be stretched into place to accommodate for slight variations in fastener spacing and misalignment thereof while holding the screen material tight across the opening regardless of such minor variations in fastener alignment with the connectors.

The edging material 20 across the centre seam 24 includes reflectors 48 and indicia 49 located thereon. The indicia 49 may be in the form of a logo or other identifying marks which are clearly visible in contrast to the screen material. Similarly the reflectors 48 provide a clear indication even to persons in a vehicle approaching the building that the screen material is in place across the opening to prevent accidental collision of vehicles with screen material spanning the door opening in a garage for example. The reflectors 48 and indicia, are accordingly located generally in a central location on the screen material, but may be re-located to any visible location thereon.

Removal of the screen from the opening is accomplished by simply releasing the connectors from the respective fasteners 34 about which they are stretched. Once released the screen material can be folded for storage. The fasteners 34 remain secured in place within the perimeter frame for later use of the screen system.

While one embodiment of the present invention has been described in the foregoing, it is to be understood that other embodiments are possible within the scope of the invention. The invention is to be considered limited solely by the scope of the appended Claims.

1. A screen system for an opening in a building, the opening having a perimeter frame, the system comprising:
a plurality of fasteners securable to the perimeter frame of the opening at spaced positions therealong; and
a sheet of screen material securable to the fasteners for spanning the opening.

2. The system according to claim 1 wherein the screen material includes a plurality of connectors at spaced positions about a periphery thereof which are selectively securably to the fasteners.

3. The system according to claim 2 wherein the connectors are formed of resilient elastic material.

4. The system according to claim 2 wherein the fasteners include an anchoring portion for securement within the perimeter frame of the opening and a head portion of enlarged diameter and wherein the connectors comprise a loop of material securable about the head portion of the fasteners.

5. The system according to claim 4 wherein the connectors are formed of resilient elastic material for being stretched about the head portion of the respective connectors.

6. The system according to claim 1 wherein there is provided a horizontally extending seam spanning the screen material.

7. The system according to claim 6 wherein connectors are provided about a periphery of the screen material for securement to the fasteners and wherein at least one connector is provided in alignment with the seam.

8. The system according to claim 6 wherein there are provided visual markers on the seam in the screen material.

9. The system according to claim 1 wherein there is provided at least one visual marker centrally located within the screen material.

10. The system according to claim 9 wherein said at least one visual marker comprises a reflector.

11. The system according to claim 1 wherein the sheet of flexible screen material is only slightly larger in dimension than a conventional garage door opening size.

12. The system according to claim 1 wherein there is provided reinforcement material along a bottom edge of the screen material.

13. The system according to claim 12 wherein the reinforcement material is formed in a loop for slidably receiving an elongate rod of rigid material therethrough.

14. A method of supporting a sheet of screen material spanning an opening in a building having a perimeter frame, the method comprising:
mounting a plurality of fasteners on the perimeter frame of the opening at spaced positions therealong;
securing a peripheral edge of the sheet of screen material to the fasteners to span the opening.

15. The method according to claim 14 including providing a plurality of connectors about the peripheral edge of the sheet of screen material, the plurality of fasteners being mounted on the perimeter frame in alignment with the connectors on the sheet of screen material.

16. The method according to claim 15 wherein the connectors are formed of resilient elastic material and wherein the method includes stretching the connectors about the respective fasteners.

17. The method according to claim 14 including providing visual markers centrally located on the sheet of screen material.

18. The method according to claim 17 wherein the markers comprise reflective material.

19. The method according to claim 14 including detaching the sheet of screen material from the fasteners after use and folding the sheet of screen material for storage.
